(19) United States
(12) Patent Application Publication
(10) Pub. No.: US 2024/0353809 A1
(43) Pub. Date: Oct. 24, 2024

(54) CONTROL OF A MULTI SPINDLE MACHINE TOOL

(71) Applicant: Siemens Aktiengesellschaft, 80333 München (DE)

(72) Inventors: Loay Alkafafi, Erlangen (DE); RALF SPIELMANN, Stuttgart (DE); PHILIP JOACHIM RACK, Stuttgart (DE)

(73) Assignee: Siemens Aktiengesellschaft, 80333 München (DE)

(21) Appl. No.: 18/643,139

(22) Filed: Apr. 23, 2024

(30) Foreign Application Priority Data
Apr. 24, 2023 (EP) 23169374.8

(51) Int. Cl. G05B 19/18; G05B 19/408

(52) U.S. Cl. CPC G05B 19/182; G05B 19/408; G05B 2219/50235

(57) ABSTRACT

For control of a multi spindle machine tool (1), which has a first tool spindle (2a, 2b) and a second tool spindle (2a, 2b) able to be controlled independently thereof, a first workpiece (5a, 5b) and a second workpiece (5a, 5b) are processed by a parts program synchronized in two processing channels being processed. The processing of the parts program includes an activation of first machine axes for guidance of the first tool spindle (2a, 2b) in accordance with a first tool track and the processing of the parts program includes an activation of second machine axes for guidance of the second tool spindle (2a, 2b) in accordance with a second tool track. A processing result of the first workpiece (5a, 5b) at an end of the first tool track is the same as a processing result of the second workpiece (5a, 5b) at an end of the second tool track. The first machine axes and the second machine axes are activated in such a way that a difference in time between reaching the end of the first tool track and reaching the end of the second tool track is less than or equal to a predetermined limit value.

The present invention relates to a method for computer-aided numerical control of a multi spindle machine tool, which has a first tool spindle equipped with a first tool and a second tool spindle able to be controlled independently of the first tool spindle and equipped with a second tool. The invention further relates to a multi spindle machine tool, having a first tool spindle able to be equipped with a tool and a second tool spindle able to be controlled independently of the first tool spindle and equipped with a second tool. Moreover the invention relates to a computer program and to a computer-readable memory medium.

In the field of machine tools, some machines are designed as multi spindle machine tools, also referred to a multi spindle machines. Said machines have two or more tool spindles for corresponding processing of two or more workpieces. Thereby two or more processing operations and thus the movement guidance and spindle control would have to be undertaken at the same time, i.e. synchronously. The use of a number of synchronous processing units on one machine is able to be applied in a wide diversity of technologies, for example for milling, turning, grinding and so forth. Multi spindle machine tools with precisely two tool spindles are also referred to as double spindle machine tools or double spindle machines.

On double spindle machines for example two workpieces can be processed simultaneously with two tools, so that, at the end of the processing, two nominally identical workpieces are available. The processing of the two workpieces occurs synchronously. Thus the output on a double spindle machine is twice as high compared to a single spindle machine. A double spindle machine can however be operated to produce just one workpiece, the second spindle is then not active.

With double spindle machines there are various concepts, the complexity of which can be tailored for example to the respective demands of production and accuracy. The concepts differ constructively for example in the degrees of freedom of the individual tool spindles or processing units.

In simple double spindle machines the two tool spindles are rigidly connected mechanically to one another. The spindle assembly is then moved by the common axes, for example x, y and z axis. A more complex concept provides for the two tool spindles each to have independent z axes. This enables the tool spindles to be positioned differently in the z direction. A yet more complex concept makes it possible, through the use of compensation axes, which are set up on the main axes in a redundant manner, to move the tool spindles and thus the tools in all three axial directions, but only for comparatively short ranges of movement.

An especially high accuracy can be achieved by what are known as true multi spindle machine tools, i.e. multi spindle machine tools with two or more autonomous tool spindles, i.e. tool spindles able to be controlled and thus able to be moved independently of one another. The two tool spindles are then for example each equipped with a separate x, y and z axis. Instead of this or in addition to it, depending on form of embodiment and technology, further linear axes and/or axes of rotation can be provided which are independent in each case for both tool spindles.

The tool spindles are then for example operated and controlled via one and the same CNC controller, for example via a separate processing channel for each tool spindle in each case. The individual axes of the tool spindles can partially use the same guide rail.

One advantage of true multi spindle machine tools lies in the fact that the various tool spindles for manufacture of nominally identical workpieces can be equipped with tools that, despite likewise nominally being identical, have dimensions that differ from one another for example due to different levels of wear. The independent control of the various tool spindles can compensate for the different dimensions.

For an optimal utilization of the shared workspace or a compact construction of the machine tool it is desirable to design a mechanical offset between the two tool spindles to be as small as possible, for example less than 1 m or also in the range of 500 mm. To enable small distances of this kind to be able to be realized mechanically, the movable stands on which the tool spindles are mounted, or other movable components, would however only be able to be at a short distance from one another, of for example a few millimeters. The danger of possible collisions would therefore exist. These would exist above all if the tool spindles, as explained above, were to be controlled differently to compensate for different tool dimensions.

Also other deviations relating to the tool spindles, such as zero point displacements, different dynamic restrictions, mechanical tolerances or different embodiments of the spindles mean that an offset can result and thereby potentially a risk of a collision.

EP0407589B1 discloses an NC command system for a CNC lathe with a number of tool spindles, of which the positions and spindle speeds can be controlled independently of one another. Where necessary coupling relationships between the tool spindles will be set in accordance with a working program, in order to enhance the working efficiency.

An object of the present invention, in the control of multi spindle machine tools of the type stated in the introduction, is to reduce the risk of collisions.

This object is achieved by the subject matter of the independent claims in each case. Advantageous developments and preferred forms of embodiment are the subject matter of the dependent claims.

The invention is based on the idea of processing the same parts program in a synchronized manner in two processing channels in order to process a first workpiece by means of a first tool, with which a first tool spindle is equipped, and a second workpiece by means of a second tool, with which a second tool spindle is equipped. In this case the tool spindles are moved differently, despite having an identical parts program, so that the two tool spindles are force-synchronized.

In accordance with one aspect of the invention a method for Computerized Numerical Control (CNC), of a multi spindle machine tool is specified. The multi spindle machine tool has a first tool spindle equipped with a first tool and a second tool spindle equipped with a second tool. The second tool spindle is able to be controlled in this case independently of the first tool spindle.

A first workpiece is processed by means of the first tool, by a predetermined parts program being processed in a first processing channel, in particular by means of the control apparatus. A second workpiece is processed by means of the second tool, by the parts program being processed in a second processing channel synchronized with the first processing channel, in particular by means of the control apparatus. The processing of the parts program in the first processing channel includes an activation of first machine axes of the multi spindle machine tool for guiding the first tool spindle in accordance with a first tool track. The processing of the parts program in the second processing channel includes an activation of second machine axes of the multi spindle machine tool for guidance of the second tool spindle in accordance with a second tool track.

Through the processing of the parts program in the first processing channel and the second processing channel, the first tool spindle is thus guided in accordance with the first tool track and the second tool spindle is guided in accordance with the second tool track.

In this case a result of the processing of the first workpiece at an end of the first tool track is the same as a result of the processing of the second workpieces at an end of the second tool track. To this end, the first machine axes and the second machine axes are activated in such a way that a difference in time between the first tool reaching an end of the first tool track and the second tool reaching the end of the second tool track is less than or equal to a predetermined limit value.

The first tool spindle can be guided by corresponding activation and movement of the first machine axes and the second tool spindle by a corresponding activation and movement of the second machine axes. The first machine axes or the second machine axes can each include one or more linear or translational axes, for example an x, a y and a z axis. As an alternative or in addition the first machine axes of the second machine axes can include respective rotation axes.

The tool spindles are able to be controlled independently of one another. This can be understood in particular as the first machine axes being able to be controlled and moved independently of the second machine axes. Thus it is possible in principle, by means of the first tool spindle and the second tool spindle, to process parts programs that are different from one another.

The parts program being processed in a synchronized manner in the first and the second processing channel can in particular be interpreted such as the processing being undertaken at the same time or in parallel and accordingly the activation of the first machine axes being undertaken synchronized with the activation of the second machine axes, so that the movement of the first tool spindle is also undertaken synchronized with the movement of the second tool spindle, i.e. in particular at the same time.

In particular the synchronized processing of the parts programs in the two processing channels and the resulting synchronized movement of the first tool spindle and the second tool spindle can be understood as the movement of the first tool spindle along the first tool track up to a predetermined tolerance value beginning and ending simultaneously with the movement of the second tool spindle along the second tool track. Optionally further intermediate positions can be predetermined on the first and the second tool track, which will be reached at the same time according to the synchronized processing and the synchronized movement of the tool spindles up to a predetermined tolerance value.

Further, in various forms of embodiment, first tool dimensions of the first tool are obtained, in particular by a control apparatus of the multi spindle machine tool, which is configured for CNC control of the first tool spindle and the second tool spindle. In various forms of embodiment second tool dimensions of the second tool can be obtained, in particular by the control apparatus. The first tool dimensions differ in this case from the second tool dimensions.

In such forms of embodiment a difference in speed between a first average track speed of the first tool track and a second average track speed of the second tool track is set by the respective activation of the first machine axes and the second machine axes depending on the first tool dimensions and the second tool dimensions, in particular automatically, for example by means of the control apparatus depending on the parts program.

Since the same parts program is processed in both processing channels, the first tool is nominally identical to the second tool. The different tool dimensions result for example from different degrees of wear of the first tool and the second tool. Nominal dimensions for the first workpiece and the second workpiece are further correspondingly identical.

Depending on the technology of the multi spindle machine tool, thus whether for example it involves a machine tool for milling, turning, grinding or drilling and so forth, different first tools or second tools are employed. Accordingly the type of the tool dimensions can also differ depending on technology. In particular the first and the second tool are defined by respective required dimensions, where necessary inclusive of corresponding tolerance ranges, for one or more dimensions, for example length dimensions or radii and so forth. The first tool dimensions or the second tool dimensions correspond to the actual dimensions according to these required dimensions and therefore generally differ from one another for the first and the second tool.

The first and the second tool dimensions can be established before the inventive method is carried out by conventional measurements, for example manual or automatic measurements, and provided to the control apparatus. It is also possible, in some forms of embodiment of the inventive method, for the first and/or the second tool dimensions to be determined in a method step of the inventive method, in particular automatically, for example by means of the multi spindle machine tool itself.

The first tool dimensions differing from the second tool dimensions can in particular be understood as the first tool dimensions including one or more first actual values for the first tool and as the second tool dimensions including one or more actual values for the second tool, wherein at least one of the first actual values differs from a corresponding second actual value.

The first tool track and the second tool track, in particular their respective spatial course, is given by the parts program, i.e. in particular predetermined required movements or required dimensions of the parts program, in combination with the first tool dimensions and the second tool dimensions.

By the first tool dimensions differing from the second tool dimensions, there is provision in corresponding forms of embodiment, for synchronized movement of the tool spindles, for an adjustment of the average track speeds of the first tool track and the second tool track. The more the first tool dimensions differ from the second tool dimensions, the greater in particular is the difference in speed that can be set for reaching the above-mentioned positions at the start and at the end or during the first and the second tool track simultaneously up to the corresponding tolerance values.

The exact relationship between the difference in speed and the difference in the first and second tool dimensions depends on the one hand on how the tools are embodied and on the other on how the processing result for the workpieces is embodied. If the respective processing result is predetermined however, in particular by the parts program, and if the differences in the tool dimensions are known, then it can always be calculated by geometric considerations how the average speeds must differ from one another between the two tool tracks so that the synchronized movement is achieved.

The difference in speed between the average track speed of the first tool track and the average track speed of the second tool track can be achieved in a different way. For example the tool spindles can be moved continuously, wherein the average track speed of one of the tracks is less than that of the other track. It is also possible that for example one of the tool spindles will be moved continuously, whereas the other tool spindle will only be moved continuously in parts, i.e. stopped once or a number of times along the corresponding tool track in order to reduce the corresponding track speed on average.

It should further be pointed out that the first tool track and the second tool track do not necessarily correspond to a complete processing step for processing the workpieces, but might possibly just be a part of such a processing step.

The difference in speed can also be set in different ways, in particular by the control apparatus, for example directly or indirectly.

For example the difference in speed can be calculated from the required specifications of the parts program and the difference in the tool dimensions and the corresponding dynamic characteristic values of the first and the second machine axes, i.e. in particular their axis speeds and/or axis accelerations and/or axial jerks can be selected as a function of the difference in speed calculated in this way by the control apparatus. In other forms of embodiment the dynamic characteristic values of the machine axes can be calculated directly from the difference between the tool dimensions and the required specifications of the parts program, so that there is synchronized movement of the tool spindles.

In various forms of embodiment, the difference in speed, in addition to the difference for the tool dimensions, can also depend on the current actual values or required values for the tool dimensions.

The setting of the difference in speed as a function of the first tool dimensions and the second tool dimensions thus in particular enables a difference between the processing times of the first workpiece and the second workpiece to be minimized or brought below a predetermined tolerance value. In this way it can be ensured that the deviation of the individual axis positions at that moment and the deviation of the tool spindle positions remain at least approximately constant while the first and the second workpiece are being processed. In this way the risk of collisions between the first tool spindle and the second tool spindle or between frame elements, stands or other movable components is reduced. As a result a smaller working space of the multi spindle machine tool can be achieved.

The difference in speed in this case is in particular not explicitly present in the parts program, i.e. it does not have to be expressly programmed by the user. Instead the control apparatus can calculate or set this with the aid of the difference between the tool dimensions.

Thus in particular a forced synchronization of the two processing channels is brought about, by the shorter track being forcibly slowed down due to the deviations in the tool dimensions in order to bring about an adaptation to the longer track.

In accordance with at least one form of embodiment, the difference in speed is calculated as a function of the first tool dimensions and the second tool dimensions, in particular by means of the control apparatus. The difference in speed is in particular calculated as a function of the first tool dimensions and the second tool dimensions as well as required specifications in accordance with the parts program.

Respective dynamic axis variables for the first machine axes and for the second machine axes are calculated as a function of the difference in speed. The difference in speed is set by the activation of the first machine axes and the second machine axes being undertaken according to the calculated respective dynamic axis variables.

The dynamic axis variables thus in particular contain first dynamic axis variables for the first machine axes and second dynamic axis variables for the second machine axes.

The respective dynamic axis variables can for example contain respective axis speeds of the first machine axes or of the second machine axes, respective axis accelerations of the first machine axes or of the second machine axes and/or respective axis jerks of the first machine axes or of the second machine axes and/or respective axis snaps of the first machine axes or of the second machine axes. The snap in this case is the temporal derivative of the jerk, i.e. the fourth temporal derivative of the location. Where necessary higher derivatives of the location can also be taken into account.

In accordance with at least one form of embodiment, respective dynamic axis variables of the first machine axes and the second machine axes are calculated as a function of the first tool dimension and the second tool dimension, in particular by means of the control apparatus. The difference in speed is set by the activation of the first machine axes and the second machine axes taking place according to the calculated respective dynamic axis variables.

In other words, in such forms of embodiment, the difference in speed is not explicitly calculated, but the difference in speed is set indirectly by the setting of the respective dynamic axis variables. The respective dynamic axis variables can in particular be calculated as a function of the first tool dimensions and the second tool dimensions and as a function of the required specifications in accordance with the parts program.

In accordance with at least one form of embodiment, the respective dynamic axis variables contain respective axis speeds of the first machine axes and the second machine axes.

In particular the first dynamic axis variables contain first axis speeds of the first machine axes and the second dynamic axis variables contain second axis speeds of the second machine axes.

The respective axis speeds can for example involve speeds that are constant or constant at some points during the respective tool track or they can involve corresponding target speeds for the corresponding machine axes. The respective axis speeds can be predetermined for example by the maximum permissible axis accelerations reached or the axis accelerations can likewise be predetermined, or a range can be predetermined for the axis accelerations.

Through the calculation of the axis speeds or the derivation of the axis speeds from the calculated difference in speed, the difference in speed can be set in a simple way.

In accordance with at least one form of embodiment, the respective dynamic axis variables contain respective axis accelerations of the first machine axes and the second machine axes. In particular the first dynamic axis variables contain respective axis accelerations of the first machine axes and the second dynamic axis variables of the second machine axes contain respective axis accelerations of the second machine axes.

In particular the first dynamic axis variables contain first axis accelerations of the first machine axes and the second dynamic axis variables contain second axis accelerations of the second machine axes.

The respective axis accelerations can for example involve accelerations that are constant or constant in parts during the respective tool track or corresponding target accelerations for the corresponding machine axes can be involved. The respective axis accelerations can be achieved for example by the maximum permissible axial jerks, or the axial jerks can likewise be predetermined or a range for the axial jerks can be predetermined.

In accordance with at least one form of embodiment, the respective dynamic axis variables contain respective axial jerks of the first machine axes and the second machine axes. In particular the first dynamic axis variables contain respective axial jerks of the first machine axes and the second dynamic axis variables of the second machine axes contain respective axial jerks of the second machine axes.

In particular the first dynamic axis variables contain first axial jerks of the first machine axes and the second dynamic axis variables contain second axial jerks of the second machine axes.

In accordance with at least one form of embodiment, the difference in speed is set by at least one first stop interval being determined as a function of the first tool dimensions and the second tool dimensions and by the first tool spindle being stopped along the first tool track during the at least one first stop interval. As an alternative, depending on the difference between the first tool dimensions and the second tool dimensions, in particular by means of the control apparatus, at least one second stop interval is determined, and the second tool spindle is stopped along the second tool track during the at least one second stop interval.

Through the at least one first stop interval the movement of the first tool spindle is thus artificially slowed down in order to achieve the synchronicity between the two processing channels, or by the at least one second stop interval the movement of the second tool spindle is artificially slowed down, in order to establish the synchronicity. The difference in speed then results from the at least one first stop interval or from the at least one second stop interval.

In particular either the at least one first stop interval is determined and the first tool spindle is stopped accordingly or the at least one second stop interval is determined and the second tool spindle is stopped accordingly in the way described above.

Which of the two cases occurs depends on whether the tool dimensions differ and how the required specifications are created in accordance with the parts program. In particular the tool spindle that is artificially slowed down is the one of which the track length is shorter.

A stop interval can be understood as a period of time during which all corresponding machine axes are stopped, i.e. are stationary. During the at least one first stop interval the first machine axes are thus stationary or during the at least one second stop interval the second machine axes are stationary.

For example the at least one first stop interval can contain two or more first stop intervals, in particular three or more first stop intervals. For example the at least one second stop interval can contain two or more second stop intervals, in particular three or more second stop intervals. The more stop intervals are provided, the smaller the maximum deviation in position between the two tools remains.

In forms of embodiment in which the at least one first stop interval or the at least one second stop interval is provided, the respective dynamic axis variables, in particular the respective axis speeds, of the first machine axes or of the second machine axes can be chosen to be essentially the same outside of the corresponding stop intervals.

In accordance with at least one form of embodiment, in particular by means of the control apparatus by the activation of the first machine axes and the second machine axes, a difference in acceleration between a first track acceleration of the first tool track and a second track acceleration of the second tool track is set as a function of the difference between the first tool dimensions and the second tool dimensions.

What has been said in relation to the difference in speed can be transferred by analogy to the difference in acceleration. Through the corresponding setting of the difference in acceleration an even better synchronization of the two movements of the two tool spindles is able to be achieved.

In accordance with at least one form of embodiment, in particular by means of the control apparatus by the activation of the first machine axes and the second machine axes, a difference in jerk between a first track jerk of the first tool track and a second track jerk of the second tool track can be set as a function of the difference between the first tool dimensions and the second tool dimensions.

What has been said in relation to the difference in speed can be transferred by analogy to the difference in jerk. Through the corresponding setting of the difference in jerk an even better synchronization of the two movements of the two tool spindles is able to be achieved.

In accordance with at least one form of embodiment, identical required dimensions are predetermined in each case for the first workpiece and the second workpiece and the parts program is predetermined in accordance with the required dimensions.

In other words all required dimensions for the first workpiece are equal to the corresponding required dimensions for the second workpiece. The finished first workpiece is thus nominally identical to the finished second workpiece. The parts program is specified, in particular programmed, in such a way that the identical required dimensions result. For example identical required dimensions for the first and the second tool can also be assumed for this.

In accordance with at least one form of embodiment the first tool dimensions and the second tool dimensions involve actual dimensions and required dimensions for the first tool in each case and are identical to required dimensions for the second tool.

In other words the difference between the first dimensions and the second dimensions is a result of wear or wear and tear of the first or the second tool.

In accordance with at least one form of embodiment the first tool dimensions are measured by means of a measurement apparatus of the first multi spindle machine tool and/or the second tool dimensions are measured by means of a measurement apparatus of the second multi spindle machine tool.

In this way the measured first and/or second tool dimensions can be transferred from the measurement apparatus and/or the further measurement apparatus directly to the control apparatus.

In accordance with at least one form of embodiment respective parameter values of at least one mechanical parameter and/or of at least one dynamic parameter and/or of at least one position parameter can differ from one another for the first tool spindle and the second tool spindle.

For example the at least one mechanical parameter contains the tool dimensions of the first tool or of the second tool. Not only can an asynchronous movement of the tool spindles be caused by different tool dimensions of the first and of the second tool however. This can also be the case for deviations of the at least one dynamic parameter and/or the at least one position parameter.

The inventive method can also achieve a forced synchronization in these cases.

What has been said in relation to different tool dimensions therefore applies by analogy for situations in which the parameter values of the other mechanical parameters differ from one another and/or parameter values of the at least one dynamic parameter and/or of the at least one position parameter.

In accordance with at least one form of embodiment, the at least one dynamic parameter contains a maximum permitted or possible advance of the first tool spindle or of the second tool spindle.

If for example there is provision for a specific tool advance in the parts program, then it can occur that this can be realized by one tool spindle, but not by the other tool spindle however due to predetermined dynamic restrictions. Potential asynchronicities resulting from this can be reduced or prevented by the proposed method.

In accordance with at least one form of embodiment, the at least one position parameter contains a zero point position of the first tool or of the second tool.

Slight displacements of the zero point position can be produced by different clamping of the tools. Potential asynchronicities resulting from this can be reduced or prevented by the proposed method.

In accordance with at least one form of embodiment, the difference in speed between a first average track speed of the first tool track and a second average track speed of the second tool track is set so that the difference in time is less than or equal to the limit value.

In accordance with at least one form of embodiment, the difference in speed are calculated as a function of the parameter values for the first tool spindle and the second tool spindle. The respective dynamic axis variables for the first machine axes and the second machine axes are calculated as a function of the difference in speed.

The difference in speed is set by the activation of the first machine axes and the second machine axes being undertaken according to the calculated respective dynamic axis variables.

In accordance with at least one form of embodiment, the respective dynamic axis variables of the first machine axes and the second machine axes are calculated as a function of the parameter values for the first tool spindle and the second tool spindle.

The difference in speed is set by the activation of the first machine axes and the second machine axes taking place according to the calculated respective dynamic axis variables.

In accordance with at least one form of embodiment, the difference in speed is set, as a function of the parameter values for the first tool spindle and the second tool spindle, by at least one first stop interval being determined and by the first tool spindle being stopped along the first tool track during the at least one first stop interval.

In accordance with at least one form of embodiment, the difference in speed is set, as a function of the parameter values for the first tool spindle and the second tool spindle, by at least one first stop interval being determined and by the first tool spindle being stopped along the first tool track during the at least one second stop interval

In accordance with at least one form of embodiment, the difference in acceleration between a first track acceleration of the first tool track and a second track acceleration of the second tool track and/or the difference in jerk between a first track jerk of the first tool track and a second track jerk of the second tool track and/or the difference in snap between a first track snap of the first tool track and a second track snap of the second tool track is set as a function of the parameter values for the first tool spindle and the second tool spindle.

In accordance with a further aspect of the invention, a multi spindle machine tool is specified. The multi spindle machine tool has a first tool spindle able to be equipped or equipped with a first tool and a tool spindle able to be controlled independently of the first tool spindle and able to be equipped or equipped with a with a second tool.

The multi spindle machine tool has a control apparatus, which is configured for CNC control of the first tool spindle and the second tool spindle.

The control apparatus is configured, for processing of the first workpiece by means of the first tool, to process a predetermined parts program in a first processing channel and, for processing the second workpiece by means of the second tool, to process the parts program in a second processing channel synchronized with the first processing channel. The control apparatus is configured, for processing of the parts program in the first processing channel, to activate first machine axes for guidance of the first tool spindle in accordance with a first tool track and, for processing of the parts program in the second processing channel, to activate second machine axes for guidance of the second tool spindle in accordance with a second tool track, wherein a processing result of the first workpiece at an end of the first tool track is the same as a processing result of the second workpiece at an end of the second tool track. The control apparatus is configured to activate the first machine axes and the second machine axes in such a way that a difference in time between reaching the end of the first tool track and reaching the end of the second tool track is less than or equal to a predetermined limit value.

The control unit in particular contains one of more computing units. A computing unit can be understood in particular as a data processing device that contains a data processing circuit. The computing unit can thus in particular process data for carrying out computing operations. This might also include operations for carrying out indexed accesses to a data structure, for example a look-up table (LUT).

The computing unit can in particular contain one or more computers, one or more microcontrollers and/or one or more integrated circuits, for example one or more application-specific integrated circuits (ASIC), one or more Field-Programmable Gate Arrays (FPGA), and/or one or more systems on a chip (SoC). The computing unit can also contain one or more processors, for example one or more microprocessors, one or more Central Processing Units (CPU), one or more Graphics Processing Units (GPU) and/or one or more signal processors, in particular one or more Digital Signal Processors (DSP). The computing unit can also contain a physical or a virtual network of computers or others of the said units.

In various exemplary embodiments the computing unit contains one or more hardware and/or software interfaces and/or one or more memory units.

A memory unit can be embodied as a volatile data memory, for example as a dynamic random access memory (DRAM) or static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as flash memory or flash EEPROM, as a ferroelectric random access memory (FRAM), as a magnetoresistive random access memory (MRAM) or as a phase-change random access memory (PCRAM).

Further forms of embodiment of the inventive multi spindle machine tool follow on directly from the various embodiments of the inventive method and vice versa. In particular the individual features and corresponding explanations as well as advantages relating to the various forms of embodiment for the inventive method can be transferred by analogy to the corresponding forms of embodiment of the inventive multi spindle machine tool. In particular the inventive multi spindle machine tool is embodied or programmed for carrying out an inventive method. In particular the inventive multi spindle machine tool carries out the inventive method.

In accordance with a further aspect of the invention a computer program with commands is specified. When the commands are executed by the control apparatus of the multi spindle machine tool in accordance with the invention, the commands cause the multi spindle machine tool to carry out the inventive method for control of a multi spindle machine tool.

The commands can for example be present as program code. The program code can for example be provided as binary code or Assembler and/or as source code of a programming language, for example C, and/or as program script, for example Python.

In accordance with a further aspect of the invention a computer-readable memory medium is specified, which stores an inventive computer program.

Further features of the invention emerge from the claims, the figures and the description of the figures. The features and combinations of features mentioned here in the description, as well as the features and combinations of features mentioned below in the figures or in the description of the figures, can be included not only in the combination specified in each case, but also in other combinations of the invention.

In particular other versions and combinations of features can be included in the invention that do not have all features of an originally formulated claim. As well as this, versions and combinations of features can be included in the invention that go beyond the combinations of features set out in the references of the claims or that differ from the latter.

The invention will be explained in greater detail below with the aid of concrete exemplary embodiments and associated schematic drawings. In the figures elements that are the same or have the same functions are labeled with the same reference characters. The description of the same elements or elements with the same functions might not necessarily be repeated in relation to different figures.

In the figures:

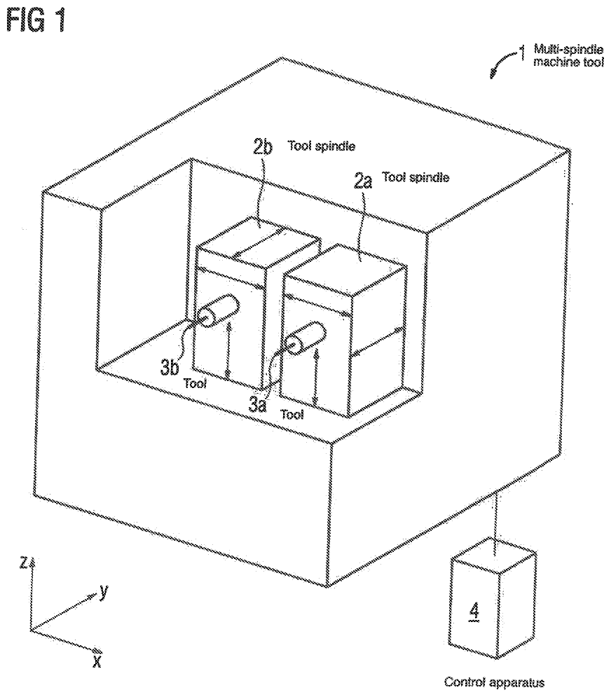

FIG. 1 shows a schematic diagram of an example of a form of embodiment of an inventive multi spindle machine tool,

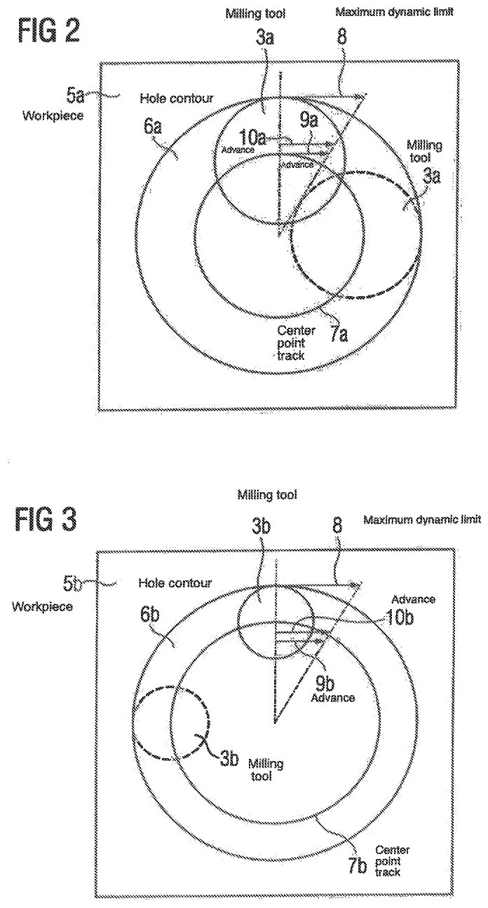

FIG. 2 shows a schematic diagram of a first workpiece and of a first tool for processing the first workpiece;

FIG. 3 shows a schematic diagram of a second workpiece and of a second tool for processing the second workpiece;

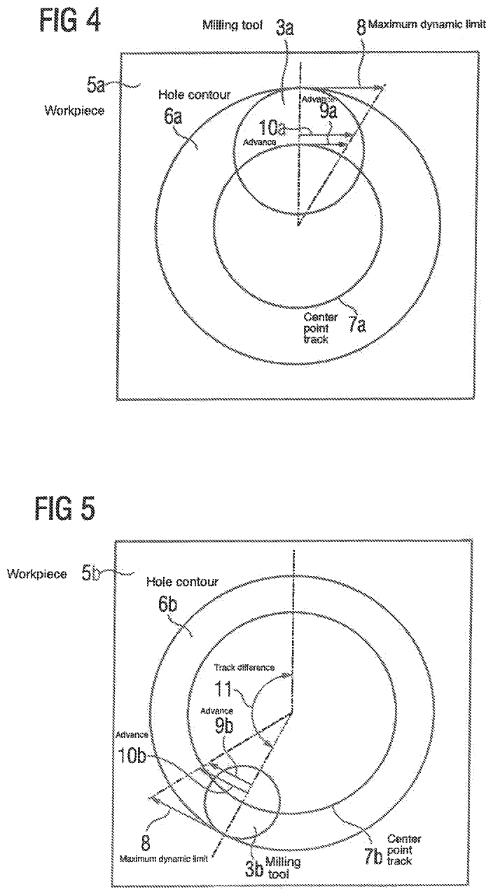

FIG. 4 shows a further schematic diagram of the first workpiece and the first tool; and

FIG. 5 shows a further schematic diagram of the second workpiece and the second tool.

Shown schematically in FIG. 1 is an example of a form of embodiment of an inventive multi spindle machine tool 1. The multi spindle machine tool 1 is shown in the example in FIG. 1 as a double spindle machine tool. The explanations can however also be transferred by analogy to machine tools with more than two tool spindles.

The multi spindle machine tool 1 has a first tool spindle 2a, which is equipped with a first tool 3a, and also a second tool spindle 2b, which is equipped with a second tool 3b. The second tool spindle 2b is able to be controlled in this case independently of the first tool spindle 2a. In a non-restrictive example the first tool spindle 2a and the second tool spindle 2b are each able to be moved along parallel x axes, parallel y axes and parallel z axes as respective first machine axes or second machine axes.

The x axes in this case are at right angles to the y axes and the z axes are at right angles to the x axes and the y axes. Other translational machine axes or axes of rotation are also possible however.

The multi spindle machine tool 1 has a control apparatus 4 for CNC control of the first tool spindle 2a and the second tool spindle 2b.

In particular an inventive method for CNC control of a multi spindle machine tool 1 can be carried out by means of the inventive multi spindle machine tool 1. For processing of a first workpiece 5 (see FIG. 2) by means of the first tool 3a, the control apparatus 4 processes a predetermined parts program in a first processing channel and for processing of a second workpiece 5b (see FIG. 3) by means of the second tool 3b, the control apparatus 4 processes the same parts program in a second processing channel synchronized with the processing in the first processing channel.

In this case the control apparatus 4, for processing of the parts program in the first processing channel, activates the first machine axes for guidance of the first tool spindle 2a in accordance with a first tool track and, for processing of the parts program in the second processing channel, activates the second machine axes for guidance of the second tool spindle in accordance with a second tool track, wherein a processing result of the first workpiece 5a at an end of the first tool track is the same as the processing result of the second workpieces 5b at an end of the second tool track.

The control apparatus 4 activates the first machine axes and the second machine axes in such a way that a difference in time between reaching the end of the first tool track and reaching the end of the second tool track is less than or equal to a predetermined limit value.

For example the control apparatus 4 receives a difference between first tool dimensions of the first tool 3a and second tool dimensions of the second tool 3b. The control apparatus 4 sets a difference in speed between a first average track speed of the first tool track and a second average track speed of the second tool track depending on the difference between the first tool dimensions and the second tool dimensions.

The method will be explained in greater detail for exemplary forms of embodiment which refer to figures FIG. 2 to FIG. 5. Purely by way of example is assumed that a hole contour 6a, 6b with a diameter of 30 mm and a depth of 20 mm is to be milled by a helix with five rotations for example by means of a first milling tool 3a and a second milling tool 3b for example. The radius of the first milling tool 3a amounts in this case for example to 10 mm and a radius of the second milling tool 3b amounts for example to 9 mm. In order to mill the hole contours 6a, 6b into the first workpiece 5a or into the second workpiece 5b respectively, in the case of the first milling tool 3a, a helix with a radius of 5 mm is required and for the second tool 3b a helix with a radius of 5.5 mm. It should be pointed out that the figures FIG. 2 to FIG. 5 are not actually depicted true-to-scale. This could for example be defined or programmed as follows for a parts program for both processing channels:
T1D1
G42
G00 X=0 Y=0 Z=0
F10000
G2 I=−15 Z=−20 TURN=5
M30

This results however, for the helix through which the second milling tool 3b must travel, in a longer path of 3.1415 mm per rotation or of 15.7075 mm per helix. In this computation example a 15.7075 mm track path corresponds to a semicircular movement.

Shown in FIG. 2 or FIG. 3 respectively is also the respective center point track 7a, 7b of the first milling tool 3a or of the second milling tool 3b from above, i.e. parallel to the depth direction, for example. The resulting hole contours 6a, 6b are further shown.

As already mentioned, the same parts program is used in both processing channels, which means that the identical hole contours 6a, 6b and identical advances are programmed, shown in FIG. 2 and FIG. 3 as corresponding arrows 9a, 9b, of which the length corresponds to the amount of the programmed advance. The hole contours 6a, 6b are created through the different center point tracks 7a, 7b, which are produced from the radius of the respective milling tool 3a, 3b. Furthermore the necessary advance for the machine axes, shown in FIG. 2 and FIG. 3 by the arrows 10a, 10b with corresponding lengths, likewise depends on the radius of the respective milling tool 3a, 3b. A maximum dynamic limit for the advance for the machine axes is shown by a corresponding arrow 8.

When the advance for the machine axes, which is required for realization of the programmed advance, is greater than the maximum possible advance, then without the inventive setting of the difference in speed an asynchronous behavior would result. In FIG. 2 and FIG. 3 the first milling tool 3a and the second milling tool 3b would both be located at the beginning of the respective helix at a position at 12 o'clock, after a specific time t1 however at different positions, for example 3 o'clock for the first milling tool 3a and 9 o'clock for the second milling tool. FIG. 4 and FIG. 5 show the positions of the milling tool 3a, 3b on conclusion of the helix by a first milling tool 3a, which would then be located at 12 o'clock again. The second milling tool 3b would then for example be at 7 o'clock, so that a corresponding track difference 11 would be produced. This track difference 11 can be reduced or prevented by the invention.

The multi spindle machine tool 1 can be employed to achieve a very high productivity in the smallest space. In addition the machine axes of the multi spindle machine tool 1 can be operated close to their respective predetermined dynamic limits, where an asynchronicity can be reduced or prevented by the invention and thus the danger of collisions can be reduced.

Through various forms of embodiment of the invention a new control function is created that allows the individual track movements, for examples circles or helixes, to be balanced out across various processing channels, i.e. in particular forcibly via synchronizing the computed or predetermined available movement and orientation curve of track planning in the CNC control in the respective processing channel. This takes place in particular without explicit specifications in the parts program itself.

In some forms of embodiment, the forced synchronization can be realized by the reduction of the track speed or the reduction of the speed of the machine axes involved in the movement in one of the processing channels and thus the synchronicity of the two processing channels achieved. For example further dynamic variables of the track, i.e. for example track acceleration and/or track jerk, and/or dynamic variables of the machine axes, i.e. for example axis acceleration and/or axial jerks, can be adapted in order to improve the synchronicity of the two processing channels. In the example of FIG. 2 and FIG. 3, the processing channel for the first milling tool 3a would be deliberately braked, since the center point track 7a is shorter there. In other forms of embodiment, the synchronicity of the two processing channels can be achieved by internally created, i.e. not explicitly programmed, stop intervals.

For parameterization of the control function, a maximum static parameter can be provided as a setting parameter for the forced synchronization for example, which is produced by the difference in the tool dimensions. A maximum dynamic distance, which is produced by measurements at the dynamic limits of the different tool corrections, can be provided as the further parameter.

The control function can in particular, for nominally identical tools with different states of wear, synchronize a parts program over two or more processing channels in a simple way. This allows highly productive machine tools to be improved and optimized even further. The introduction of such a control function increases the processing speed and the quality.

Independent of the grammatical term usage, individuals with male, female or other gender identities are included within the term.

1. A method for computer-aided numerical control of a multi spindle machine tool (1), which has a first tool spindle (2a, 2b) equipped with a first tool (3a, 3b) and a second tool spindle (2a, 2b) able to be controlled independently of the first tool spindle (2a, 2b) and equipped with a second tool (3a, 3b), wherein
a first workpiece (5a, 5b) is processed by means of the first tool (3a, 3b) by a predetermined parts program being processed in a first processing channel, and a second workpiece (5a, 5b) is processed by means of the second tool (3a, 3b) by the parts program being processed in a second processing channel synchronized with the first processing channel;
the processing of the parts program in the first processing channel includes an activation of first machine axes for guidance of the first tool spindle (2a, 2b) in accordance with a first tool track and the processing of the parts program in the second processing channel includes an activation of second machine axes for guidance of the second tool spindle (2a, 2b) in accordance with a second tool track, wherein a processing result of the first workpiece (5a, 5b) at an end of the first tool track is the same as a processing result of the second workpieces (5a, 5b) at an end of the second tool track; and
the first machine axes and the second machine axes are activated in such a way that a difference in time between reaching the end of the first tool track and reaching the end of the second tool track is less than or equal to a predetermined limit value.

2. The method as claimed in claim 1, wherein respective parameter values of at least one mechanical parameter and/or at least one dynamic parameter and/or at least one position parameter differ from one another for the first tool spindle (2a, 2b) and the second tool spindle (2a, 2b).

3. The method as claimed in claim 2, wherein
the at least one mechanical parameter contains tool dimensions of the first tool (3a, 3b) or of the second (3a, 3b) tool respectively; and/or
the at least one dynamic parameter contains a maximum permissible or possible advance of the first tool spindle (2a, 2b) or of the second tool spindle (2a, 2b) respectively; and/or
the at least one position parameter contains a zero point position of the first tool (3a, 3b) or of the second tool (3a, 3b) respectively.

4. The method as claimed in one of the preceding claims, wherein a difference in speed between a first average track speed of the first tool track and a second average track speed of the second tool track is set, so that the difference in time is less than or equal to the limit value.

5. The method as claimed in claim 4 and in one of claims 2 or 3, wherein
the difference in speed is computed as a function of the parameter values for the first tool spindle (2a, 2b) and the second tool spindle (2a, 2b);
respective dynamic axis variables are computed for the first machine axes and the second machine axes as a function of the difference in speed; and
the difference in speed is set by the activation of the first machine axes and the second machine axes being undertaken according to the calculated respective dynamic axis variables.

6. The method as claimed in claim 4 and one of claims 2 or 3, wherein
respective dynamic axis variables of the first machine axes and the second machine axes are calculated as a function of the parameter values for the first tool spindle (2a, 2b) and the second tool spindle (2a, 2b); and
the difference in speed is set by the activation of the first machine axes and the second machine axes being undertaken according to the calculated respective dynamic axis variables.

7. The method as claimed in one of claims 5 or 6, wherein the respective dynamic axis variables
contain respective axis speeds of the first machine axes and the second machine axes; and/or
contain respective axis accelerations of the first machine axes and the second machine axes; and/or
contain respective axial jerks of the first machine axes and the second machine axes; and/or
contain an axial snap of the first machine axes and an axial snap of the second machine axes.

8. The method as claimed in claim 4 and one of claims 2 or 3, wherein the difference in speed is set by, as a function of the parameter values for the first tool spindle (2a, 2b) and the second tool spindle (2a, 2b),
at least one first stop interval being determined and the first tool spindle (2a, 2b) being stopped along the first tool track during the at least one first stop interval; or
at least one second stop interval being determined and the second tool spindle (2a, 2b) being stopped along the second tool track during the at least one second stop interval.

9. The method as claimed in one of claims 2 or 3, wherein
a difference in acceleration between a first track acceleration of the first tool track and a second track acceleration of the second tool track is set as a function of the parameter values for the first tool spindle (2a, 2b) and the second tool spindle (2a, 2b); and/or
a difference in jerk between at least one first track jerk of the first tool track and a second track jerk of the second tool track is set as a function of the parameter values for the first tool spindle (2a, 2b) and the second tool spindle (2a, 2b); and/or
a difference in snap between a first track snap of the first tool track and a second track snap of the second tool track is set as a function of the parameter values for the first tool spindle (2a, 2b) and the second tool spindle (2a, 2b).

10. The method as claimed in one of the preceding claims, wherein identical required dimensions are predetermined for the first workpiece (5a, 5b) and the second workpiece (5a, 5b) and the parts program is predetermined in accordance with the required dimensions.

11. The method as claimed in claim 3, wherein the tool dimensions of the first tool (3a, 3b) and/or of the second tool (3a, 3b) are measured by means of at least one measuring apparatus of the multi spindle machine tool (1).

12. A multi spindle machine tool (1) having a first tool spindle (2a, 2b) able to be equipped with a first tool (3a, 3b), a second tool spindle (2a, 2b) able to be controlled independently of the first tool spindle (2a, 2b) and able to be equipped with a second tool (3a, 3b), as well as a control apparatus (4), which is configured for computer-aided numerical control of the first tool spindle (2a, 2b) and the second tool spindle (2a, 2b) and is configured,
for processing of the first workpiece (5a, 5b) by means of the first tool (3a, 3b), to process a predetermined parts program in a first processing channel and for processing of the second workpiece (5a, 5b) by means of the second tool (3a, 3b), to process this parts program in a second processing channel synchronized with the first processing channel;
for processing of the parts programs in the first processing channel, to activate first machine axes for guidance of the first tool spindle (2a, 2b) in accordance with a first tool track and for processing of the parts programs in the second processing channel, to activate second machine axes for guidance of the second tool spindle (2a, 2b) in accordance with a second tool track, wherein a processing result of the first workpieces (5a, 5b) at an end of the first tool track is the same as a processing result of the second workpiece (5a, 5b) at an end of the second tool track; and
to activate the first machine axes and the second machine axes in such a way that the difference in time between reaching the end of the first tool track and reaching the end of the second tool track is less than or equal to a predetermined limit value.

13. A computer program having commands that, when executed by the control apparatus (4) of a multi spindle machine tool (1) in accordance with claim 12, cause the multi spindle machine tool (1) to carry out the method as claimed in one of claims 1 to 11.

14. A computer-readable memory medium, which stores a computer program as claimed in claim 13.
